(19) United States
(12) Patent Application Publication
(10) Pub. No.: US 2015/0324010 A1
(43) Pub. Date: Nov. 12, 2015

(54) Electronic computer keyboard with different alphabets

(71) Applicant: Michael Lewis Moravitz, Fairfax, VA (US)

(72) Inventor: Michael Lewis Moravitz, Fairfax, VA (US)

(21) Appl. No.: 14/545,765

(22) Filed: Jun. 4, 2014

(51) Int. Cl. G06F 3/02; G06F 3/0489; G06F 3/023

(52) U.S. Cl. CPC G06F 3/0219; G06F 3/0238; G06F 3/0489

(57) ABSTRACT

Electronic light display keyboards with interchangeable alphabets and symbols for computers.

Specifications: An electronic keyboard could be manufactured so that it could change with different displays for different alphabets and different symbols through LEDs. For example, the keyboard could change from an American English to a British English (or any other country where English is used). The symbols on the keyboard would change and it would be more adaptable, cost effective, and able to be sold in multiple locations. A switch or a software command would change the keyboard LEDs as the user would so desire. The keyboard could also change to different languages. The word-processing software would have to be compatible or changeable with the keyboard as it changes. In this way, the user could write in multiple languages more easily with one keyboard that changes to multiple alphabets or that changes the symbols used on an English alphabet keyboard for multi-country use.

The Voice of America's 1980's SNAP software by Xerox had an internal keyboard displayed on the computer screen that could change the key strokes on the standard American English keyboard. This proposed patent would move the technology to an electronic keyboard that changes the letters and symbols—and not one keyboard whose inscriptions would not change but the key strokes would be based on the SNAP keyboard displayed on the screen. Perhaps the outdated Xerox software could be updated for use on such a keyboard and linked to word-processing software in different languages or the same language i.e. English with different symbols.

1) Patents for PC keyboards;

2) Patents for LEDs;

3) Patent for Xerox interchangeable alphabet software (SNAP)
